(19) United States
(12) Patent Application Publication
(10) Pub. No.: US 2011/0273306 A1
(43) Pub. Date: Nov. 10, 2011

(54) REMOTE METERING DEVICE

(76) Inventor: Alan Henry Foy, Glasgow (GB)

(21) Appl. No.: 13/122,253

(22) PCT Filed: Oct. 7, 2009
(86) PCT No.: PCT/GB2009/051327

§ 371 Date: Jun. 8, 2011

(30) Foreign Application Priority Data
Oct. 9, 2008 (GB) 0818449.1

(51) Int. Cl. G08C 17/02

(52) U.S. Cl. 340/870.02

(57) ABSTRACT

The invention relates in particular to an integrated device for the adaptation of fluid metering devices, comprising an attachment means for attachment to the meter, a pulse generating means for generating electrical pulses at a rate dependent on the volume of fluid used, means for counting and storing the number of pulses generated during a particular time period, and communication means for communicating the stored pulse readings. Ideally these elements are integrated into a single housing, attachable to a meter by simply plugging thereto, without the need for any programming.

The present invention relates to devices for remote reading of utility meters and in particular devices to adapt conventional natural gas metering devices for remote reading and improved gas metering devices.

Devices are known for enabling a conventional gas meter, for example a diaphragm meter, to be read remotely. Examples of such devices can be obtained from Technolog and others, and have changed little in over ten years. Basically such devices attach to a gas meter via a separate low frequency pulse block (which converts the mechanical motion of the meter index into electrical pulses emitted at a rate indicative of the volume of gas used), convert the read pulses into the actual volume of gas used, and send this data, via an SMS text message (or other means), to the relevant party. Consequently, said devices need programming by a trained person at the time of fitting the gas meter, so as to calibrate the device to the meter for correct conversion, as well as setting exactly what information should be sent, when it should be sent, and how often. This also means that such devices have a complex processor to do the pulse to volume conversion, change its schedules and to allow such flexibility in its programming. Furthermore, these devices need an interface to allow the programming, and consequently may have a cable for connection to a computer, or (in a more recent development) comprise wi-fi functionality to allow such programming to be done wirelessly.

Such devices are unnecessarily complex, bulky and expensive, and the need for set-up and calibration at the time of fitting to a gas meter which adds further expense and is inconvenient. It is an aim of the present invention to address one or more of these issues.

In a first aspect of the invention there is provided an integrated device for the adaptation of fluid metering devices, comprising an attachment means for attachment to the meter, a pulse generating means for generating electrical pulses at a rate dependent on the volume of fluid used, means for counting and storing the number of pulses generated during a particular time period, and communication means for communicating the stored pulse readings.

Said fluid metering device may be any type of fluid metering device, for example a gas or water meter.

Said attachment means may comprise a universal adaptor for attaching to a wide range of meters. Said adaptor may be similar to those found on conventional low- frequency pulsing devices.

Said communication means preferably comprises wireless communication means. Said wireless communication means may comprise a standard mobile operator SIM (Subscriber Identity Module) card, and may be arranged to communicate via SMS (Short Message Service) messaging. Said communications means may further comprise a communications chip and an antenna. Said antenna may be inside the housing. Alternatively or in addition there may be provided a facility for attaching an external antenna. There may also be provided a signal strength booster.

Said device is preferably integrated into as single housing, attachable to a meter by simply plugging thereto.

Preferably said device is operable to function immediately upon attachment to the meter, without the need for programming or calibration.

Said pulse generation means may comprise a low frequency pulse transmitter of the type used to convert the rotational movement of a meter's index into electrical pulses at a rate indicative of fluid consumption. Other types of pulse generation means may be applicable depending on the type of meter.

Said device may be operable only to communicate pulse readings, without having the functionality to convert said pulse readings to the corresponding amount of fluid consumed. Consequently, said devices may be implemented solely in hardware. The elimination of the need for any software, simplifies the design, makes the device more reliable and negates the need for any end user software license agreements. Certain companies, such as the applicant company, own and maintain on-site gas meters, and therefore possess the relevant data to make such conversion centrally, based on the pulse readings and device identification sent from said device. The device may be operable to communicate with a remote meter database such that specific information, for example, the gas supplier, the unique meter reference number, meter model and meter calibration, can be identified. Consequently the devices can be simplified and made cheaper, while not requiring calibration to the particular meter it is attached to, which is a requirement for conventional remote metering devices, to allow said conversion to take place on-board, prior to communication.

Said device may be operable to count pulses generated over preset time periods, and communicate after preset intervals, said preset time periods and preset intervals being fixed. The inventors have realised that a device operating in this way is sufficient in all practical purposes, to enable remote metering and billing. Again, such a design allows simplification of the device, and simplifies set-up, as prior art devices need means to enable set-up programming to set these parameters, and trained persons to perform the set-up, when fitting.

Said device may further comprise an integral long-life battery.

Said device may also comprise means for closing the fluid supply, in response to a wireless instruction received via said communication, for example, when a premises is empty, or when an account is overdue. Said means for closing the fluid supply may comprise a remotely operated servo valve.

Said device may comprise a display, for indicating data such as battery life, signal strength, whether the device is in operation etc. In one embodiment, said device may be a simple LED display, indicating signal strength or signal received, and/or indicating whether pulses are received. Said display may be operable only on user activation.

Said device may be provided with an output for direct reading of said pulse readings.

In a further aspect of the invention there is provided a fluid metering device comprising, integrated therein: a pulse generating means for generating electrical pulses at a rate dependent on the volume of gas used, means for counting and storing the number of pulses generated during a particular time period, and communication means for communicating the stored pulse readings.

Said communication means preferably comprises wireless communication means. Said wireless communication means may comprise a standard mobile operator SIM (Subscriber Identity Module) card, and may be arranged to communicate via SMS (Short Message Service) messaging. Said communications means may further comprise a communications chip and an antenna. Said antenna may be inside the metering device. Alternatively or in addition there may be provided a facility for attaching an external antenna. There may also be provided a signal strength booster.

Said metering device may be operable only to communicate pulse readings without having the utility to convert said pulse readings to the corresponding amount of fluid consumed or interim software to receive the pulses.

Said metering device may be operable to count pulses generated over preset time periods, and communicate after preset intervals, said preset time periods and preset intervals being unalterable

Said metering device may further comprise an integral long-life battery.

Said metering device may also comprise means for closing the fluid supply, in response to a wireless instruction received via said communication, for example, when a premises is emptied, or when an account is overdue. Said means for closing the fluid supply may comprise a remotely operated servo valve.

Said metering device may comprise a display, for indicating data such as battery life, signal strength, whether the device is in operation etc.

Said metering device may be provided with an output for direct reading of said pulse readings.

In a further aspect of the invention there is provided an integrated device for the adaptation of fluid metering devices of a type which generates electrical pulses at a rate dependent on the volume of fluid used, comprising an attachment means for attachment to the meter, means for counting and storing the number of pulses generated during a particular time period, and communication means for communicating the stored pulse readings wherein said device is operable to function immediately upon attachment to the meter, without the need for programming or calibration.

All the optional features (other than those relating to the pulse generating means of that device) described with reference to the device of the first aspect of the invention above are equally applicable to the device of this further aspect.

### BRIEF DESCRIPTION OF THE DRAWINGS

Embodiments of the invention will now be described, by way of example only, by reference to the accompanying drawings, in which:

FIG. 1 shows the basic elements making up a remote metering conversion device according to one embodiment of the invention; and

FIG. 2 shows the elements of the collector/communicator block of FIG. 1 in greater detail.

### DETAILED DESCRIPTION OF THE EMBODIMENTS

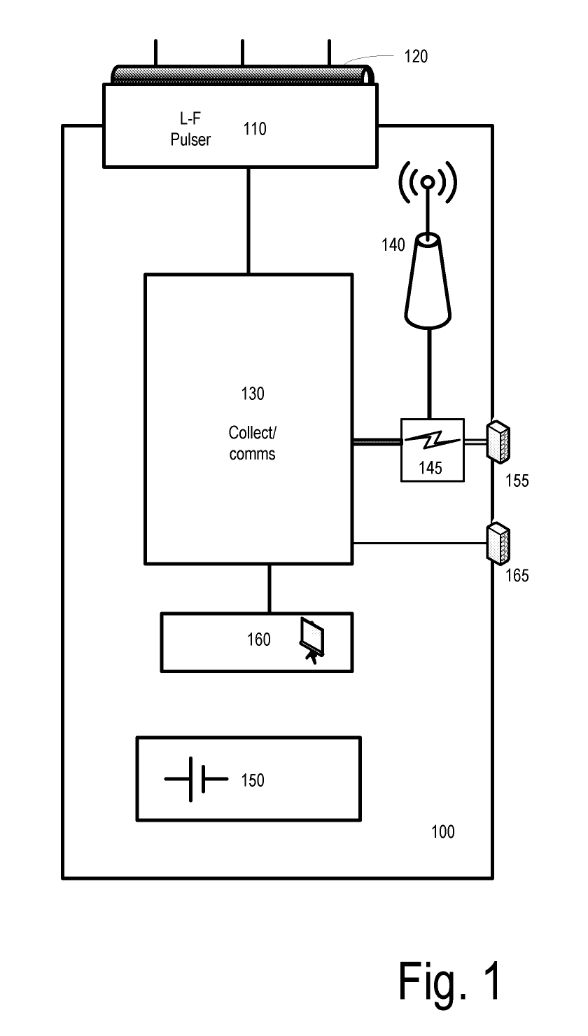

FIG. 1 is a block diagram showing the basic elements that make up a remote metering conversion device 100 according to an embodiment of the invention. It comprises a low frequency pulse transmitter 110, the low frequency pulse transmitter having a universal fixing 120 for plugging onto the majority of meter outputs (in some cases a simple adaptor may be required). The low frequency pulse transmitter feeds into the collector/communicator 130 block, which counts and stores the number of pulses consumed over given time intervals (for example, every 30 minutes). The device 100 also comprises an antenna/aerial 140 (in this embodiment via signal booster 145) to send the metering information over conventional a mobile telephone network, and a battery 150, preferably sufficient for powering the device for a number of years without charging.

Optionally, device 100 may also have a parallel output 165 for direct transmission of received pulses to an external device (possibly an RG11 telephone socket) and an LED (or possibly digital) display 160, for indicating the GSM signal strength (or simply indicating that sufficient signal strength is detected for communication), and/or a pulse test option for checking that the meter is producing pulses. Other display options include the monitoring and/or testing of the battery 150, or an indication as to whether the device 100 is operational. In all cases it is preferable that the display is only operational on the push of a button (or similar), so as to conserve battery power.

While the antennal 140 is depicted as an internal antenna, shown inside (or physically attached to) the housing, an external antenna could instead be used (attached by wire) to allow greater mobility so as to get the best signal (or, indeed any signal). In this embodiment, as well as the internal antenna 140, there is provided a socket 155 for connection to an external antenna, for use in situations where the internal antenna cannot obtain sufficient signal strength to communicate.

The low frequency pulse transmitter may be similar to or of the type manufactured by Elster-Handel GmbH, such as those designated IN-Z31/61, INZ-62 or IN-Z63. These attach to the index of the meter and comprise a reed switch which is activated each revolution of the first moving drum of the index by a pulse magnet on the drum, thereby causing a pulse to be generated.

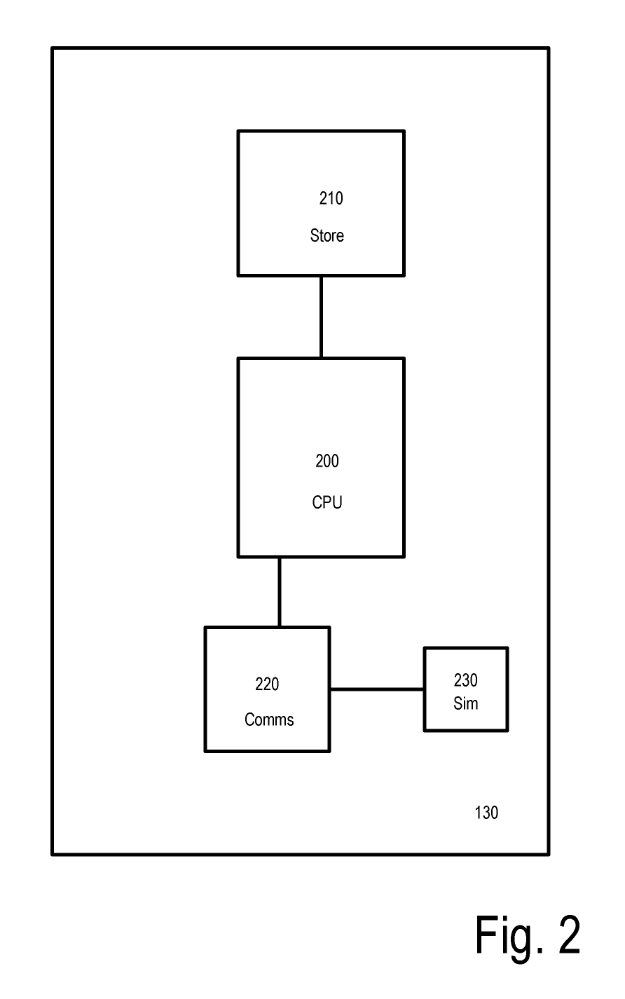

FIG. 2 is a block diagram showing the elements of the collector/communicator block 130 of FIG. 1 in more detail. It comprises a processor 200, a data store 210, a communications chip 220, and a SIM card 230.

The processor 200 is fed by the low frequency pulse transmitter block 110, acknowledges that pulses are available, and if so, instantly starts to count them, summing them every thirty minutes. Every thirty minute total will then be stored in the data store 210 until sending to the central data bank. The processor also controls the communications chip 220, initiating the transfer of the stored half hourly reads every seven days to the central data bank, along with meter referencing information. Actual communication is done using a standard SIM card 230, in the form of SMS (Short Messaging Service) text messages over a standard mobile telephone network.

The central data bank, on receipt of the messages, will store the pulse readings in unique files for every meter reference point. The central data bank possesses data on all the meter types, and in particular calibration settings sufficient to calculate the actual amount of gas consumed from each set of pulse readings received. A customer can therefore be billed accurately without the need for estimating, or the need for someone to come out and physically read the meter.

Ideally, the device described herein is very compact, with all its elements comprised within a single unit which can simply be plugged onto a customer's gas meter. The device will then immediately start operating without any need for programming or set-up. Installation is so simple, it is envisaged that it can be entrusted to the customer, without the need for an engineer or other technical expert. In particular, there will be no mains power supplies or connection to gas pipework.

Optionally, said device may also be able to receive a remote signal and, should said remote signal instruct it, turn of the gas supply by actuating a servo valve, for example, if a customer is in arrears, or where a property has been emptied. Therefore no engineer needs to be sent out to do this, saving in cost and increasing safety (both in switching off the gas at unoccupied premises, and in protecting engineers from irate customers).

Information in the central data bank could also be used for monitoring usage rates to help determine whether it has been removed without authorisation (zero reading), or if there is a gas leak (very high reading). Essentially, any reading that appears abnormal in comparison to the historical usage could be flagged by the system.

The above embodiments are for illustration only and other embodiments and variations are possible and envisaged without departing from the spirit and scope of the invention. For example, the timescales and counting periods disclosed are purely an example of convenient timescales and counting periods, and the skilled person will realise that different timescales and periods may be chosen. Furthermore, the above description is made with reference to natural gas meters, but is also applicable to other fluid metering devices, such as water meters.

The device described above is designed for attachment to conventional metering devices with a mechanical index output, designed to be read manually. More recently, meters have been designed with a pulsed output, negating the need for the low frequency pulse transmitter. Consequently, a device as described above, without the low frequency pulse transmitter but which functions immediately on connection to the meter, is envisaged, for attachment to pulsed output meters.

Also within the scope of the invention is a gas/fluid metering device with such a remote metering conversion device as described herein, or all the elements which make up the remote metering conversion device, integral to it.

1. An integrated device for the adaptation of fluid metering devices, comprising an attachment means for attachment to the meter, a pulse generating means for generating electrical pulses at a rate dependent on the volume of fluid used, means for counting and storing the number of pulses generated during a particular time period, and communication means for communicating the stored pulse readings.

2. An integrated device as claimed in claim 1 wherein said attachment means comprises a universal adaptor for attaching to a wide range of meters.

3. An integrated device as claimed in claim 2 wherein said adaptor is similar to those found on conventional low-frequency pulsing devices.

4. An integrated device as claimed in any preceding claim wherein said communication means comprises wireless communication means.

5. An integrated device as claimed in claim 4 wherein said wireless communication means comprises a standard mobile operator SIM (Subscriber Identity Module) card, and is arranged to communicate via SMS (Short Message Service) messaging.

6. An integrated device as claimed in any preceding claim wherein said communications means further comprises a communications chip.

7. An integrated device as claimed in any preceding claim wherein said communications means further comprises an antenna.

8. An integrated device as claimed in claim 7 wherein said antenna is located inside the housing, or attached thereto.

9. An integrated device as claimed in any preceding claim wherein there is provided a facility for attaching an external antenna.

10. An integrated device as claimed in any preceding claim wherein all its components are integrated into a single housing, attachable to a meter by simply plugging thereto.

11. An integrated device as claimed in any preceding claim operable to function immediately upon attachment to the meter, without the need for programming or calibration.

12. An integrated device as claimed in any preceding claim wherein said pulse generation means comprise a low frequency pulse transmitter of the type used to convert the rotational movement of a meter's index into electrical pulses at a rate indicative of fluid consumption.

13. An integrated device as claimed in any preceding claim operable only to communicate pulse readings, without having the functionality to convert said pulse readings to the corresponding amount of fluid consumed.

14. An integrated device as claimed in any preceding claim being implemented solely in hardware, without the need for any software for it to function.

15. An integrated device as claimed in any preceding claim being operable to communicate with a remote meter database such that specific information, for example, the gas supplier, the unique meter reference number, meter model and/or meter calibration, can be identified.

16. An integrated device as claimed in any preceding claim being operable to count pulses generated over preset time periods, and communicate after preset intervals, said preset time periods and preset intervals being fixed.

17. An integrated device as claimed in any preceding claim comprising an integral long-life battery.

18. An integrated device as claimed in any preceding claim also comprising means for closing the fluid supply, in response to a wireless instruction received via said communication means.

19. An integrated device as claimed in any preceding claim further comprising a display.

20. An integrated device as claimed in claim 19 wherein said display is an LED display, indicating signal strength or signal received, and/or indicating whether pulses are received.

21. An integrated device as claimed in claim 19 or 20 wherein said display is operable only on user activation.

22. An integrated device as claimed in any preceding claim further comprising an output for direct reading of said pulse readings.

23. A fluid metering device comprising, integrated therein: a pulse generating means for generating electrical pulses at a rate dependent on the volume of gas used, means for counting and storing the number of pulses generated during a particular time period, and communication means for communicating the stored pulse readings.

24. A fluid metering device as claimed in claim 23 wherein said communication means comprises wireless communication means.

25. A fluid metering device as claimed in claim 24 wherein said wireless communication means comprises a standard mobile operator SIM (Subscriber Identity Module) card, and is arranged to communicate via SMS (Short Message Service) messaging.

26. A fluid metering device as claimed in any of claims 23 to 25 wherein said communications means further comprises a communications chip.

27. A fluid metering device as claimed in any of claims 23 to 26 wherein said communications means further comprises an antenna.

28. A fluid metering device as claimed in claim 27 wherein said antenna is located inside the metering device, or attached thereto.

29. A fluid metering device as claimed in any of claims 23 to 28 wherein there is provided a facility for attaching an external antenna.

30. A fluid metering device as claimed in any of claims 23 to 29 operable only to communicate pulse readings, without having the functionality to convert said pulse readings to the corresponding amount of fluid consumed.

31. A fluid metering device as claimed in any of claims 23 to 30 being implemented solely in hardware, without the need for any software for it to function.

32. A fluid metering device as claimed in any of claims 23 to 31 being operable to communicate with a remote meter database such that specific information, for example, the gas supplier, the unique meter reference number, meter model and/or meter calibration, can be identified.

33. A fluid metering device as claimed in any of claims 23 to 32 being operable to count pulses generated over preset time periods, and communicate after preset intervals, said preset time periods and preset intervals being fixed.

34. A fluid metering device as claimed in any of claims 23 to 33 comprising an integral long-life battery.

35. A fluid metering device as claimed in any of claims 23 to 34 also comprising means for closing the fluid supply, in response to a wireless instruction received via said communication means.

36. A fluid metering device as claimed in any of claims 23 to 35 further comprising a display.

37. A fluid metering device as claimed in claim 36 wherein said display is an LED display, indicating signal strength or signal received, and/or indicating whether pulses are received.

38. A fluid metering device as claimed in claim 36 or 37 wherein said display is operable only on user activation.

39. A fluid metering device as claimed in any of claims 23 to 38 further comprising an output for direct reading of said pulse readings.

40. An integrated device for the adaptation of fluid metering devices of a type which generates electrical pulses at a rate dependent on the volume of fluid used, comprising an attachment means for attachment to the meter, means for counting and storing the number of pulses generated during a particular time period, and communication means for communicating the stored pulse readings wherein said device is operable to function immediately upon attachment to the meter, without the need for programming or calibration.

41. An integrated device as claimed in claim 40 wherein said attachment means comprises a universal adaptor for attaching to a wide range of meters.

42. An integrated device as claimed in claim 41 wherein said adaptor is similar to those found on conventional low-frequency pulsing devices.

43. An integrated device as claimed in any of claims 40 to 42 wherein said communication means comprises wireless communication means.

44. An integrated device as claimed in claim 43 wherein said wireless communication means comprises a standard mobile operator SIM (Subscriber Identity Module) card, and is arranged to communicate via SMS (Short Message Service) messaging.

45. An integrated device as claimed in any of claims 40 to 44 wherein said communications means further comprises a communications chip.

46. An integrated device as claimed in any of claims 40 to 45 wherein said communications means further comprises an antenna.

47. An integrated device as claimed in claim 46 wherein said antenna is located inside the housing, or attached thereto.

48. An integrated device as claimed in any of claims 40 to 47 wherein there is provided a facility for attaching an external antenna.

49. An integrated device as claimed in any of claims 40 to 48 wherein all its components are integrated into a single housing, attachable to a meter by simply plugging thereto.

50. An integrated device as claimed in any of claims 40 to 49 operable only to communicate pulse readings, without having the functionality to convert said pulse readings to the corresponding amount of fluid consumed.

51. An integrated device as claimed in any of claims 40 to 50 being implemented solely in hardware, without the need for any software for it to function.

52. An integrated device as claimed in any of claims 40 to 51 being operable to communicate with a remote meter database such that specific information, for example, the gas supplier, the unique meter reference number, meter model and/or meter calibration, can be identified.

53. An integrated device as claimed in any of claims 40 to 52 being operable to count pulses generated over preset time periods, and communicate after preset intervals, said preset time periods and preset intervals being fixed.

54. An integrated device as claimed in any of claims 40 to 53 comprising an integral long-life battery.

55. An integrated device as claimed in any of claims 40 to 54 also comprising means for closing the fluid supply, in response to a wireless instruction received via said communication.

56. An integrated device as claimed in any of claims 40 to 55 further comprising a display.

57. An integrated device as claimed in claim 56 wherein said display is an LED display, indicating signal strength or signal received, and/or indicating whether pulses are received.

58. An integrated device as claimed in claim 56 or 57 wherein said display is operable only on user activation.

59. An integrated device as claimed in any of claims 40 to 58 further comprising an output for direct reading of said pulse readings.
